(19) United States
(12) Patent Application Publication
(10) Pub. No.: US 2008/0049836 A1
(43) Pub. Date: Feb. 28, 2008

(54) Method and System for a Fast Video Transcoder

(75) Inventor: Stephen Purcell, Mountain View, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: C2 Microsystems

(21) Appl. No.: 11/466,719

(22) Filed: Aug. 23, 2006

(51) Int. Cl. H04N 7/12

(52) U.S. Cl. 375/240.12; 375/240.26

(57) ABSTRACT

A method and system for fast video transcoding are disclosed. In one embodiment, the system comprises a processor, memory coupled to the processor, a video processor and a display. The video processor includes an input that receives MPEG-2 data; and an output that provides a bitstream to a display on a portable video device. The video processor also includes a transcoder that processes the MPEG-2 data and generates H.264 data. The H.264 data is one fourth the resolution of the MPEG-2 data.

### FIELD OF THE INVENTION

The field of the invention relates generally to video transcoding and more particularly relates to a method and system for a fast video transcoder.

### BACKGROUND

Video is a sequence of pictures; each picture is formed by an array of pixels. The size of uncompressed video is huge. To reduce its size, video compression may be used to reduce the size and improve the data transmission rate. Various video coding methods (e.g., MPEG 1, MPEG-2, and MPEG 4) have been established to provide an international standard for the coded representation of moving pictures and associated audio on digital storage media.

Such video coding methods format and compress the raw video data for reduced rate transmission. For example, the format of the MPEG-2 standard consists of 4 layers: Group of Pictures, Pictures, Slice, Macroblock, Block. A video sequence begins with a sequence header that includes one or more groups of pictures (GOP), and ends with an end-of-sequence code. The GOP includes a header and a series of one of more pictures intended to allow random access into the video sequence.

The pictures are the primary coding unit of a video sequence. A picture consists of three rectangular matrices representing luminance (Y) and two chrominance (Cb and Cr) values. The Y matrix has an even number of rows and columns. The Cb and Cr matrices are one-half the size of the Y matrix in each direction (horizontal and vertical). The slices are one or more “contiguous” macroblocks. The order of the macroblocks within a slice is from left-to-right and top-to-bottom.

The macroblocks are the basic coding unit in the MPEG algorithm. The macroblock is a 16×16 pixel segment in a frame. Since each chrominance component has one-half the vertical and horizontal resolution of the luminance component, a macroblock consists of four Y, one Cr, and one Cb block. The block is the smallest coding unit in the MPEG algorithm. It consists of 8×8 pixels and can be one of three types: luminance (Y), red chrominance (Cr), or blue chrominance (Cb). The block is the basic unit in intra frame coding.

The MPEG-2 standard defines three types of pictures: Intra Pictures (I-Pictures) Predicted Pictures (P-Pictures); and Bidirectional Pictures (B-Pictures). Intra pictures, or I-Picture, are coded using only information present in the picture itself, and provides potential random access points into the compressed video data. Predicted pictures, or P-pictures, are coded with respect to the nearest previous I- or P-pictures. Like I-pictures, P-pictures also can serve as a prediction reference for B-pictures and future P-pictures. Moreover, P-pictures use motion compensation to provide more compression than is possible with I-pictures. Bidirectional pictures, or B-pictures, are pictures that use both a past and future picture as a reference. B-pictures provide the most compression since it uses the past and future picture as a reference. These three types of pictures are combined to form a group of picture.

The MPEG-2 transform coding algorithm includes the following coding steps: Discrete cosine transform (DCT), Quantization and Run-length encoding.

The H.264 standard obtains a higher efficiency in compression than MPEG-2. The H.264 standard is believed to utilize only 50-60% of the bit-rate used by MPEG-2 for the same quality of video. To achieve the higher efficiency, many sophisticated, processing intensive, tools are used with the H.264 standard. For example, MPEG-2 uses Huffman encoding, whereas H.264 supports both Huffman encoding and context-adaptive binary arithmetic coding (CABAC).

Another tool that H.264, MPEG-4 and H.263 (“Video Coding For Low Bit Rate Communications”, International Telecommunication Union Telecommunication Standardization Sector, Geneva, Switzerland) use is a deblocking loop filter. After a basic decoding (i.e., entropy decode, transform coefficient scaling, transform and motion compensation) a filter is applied to the decoded image to reduce the blocky appearance that compression can cause. The filtering is done “in the loop”, that is, the filtered frame is used as a reference for frames that are subsequently decode and used for motion compensation. The H.264 standard also allows macroblocks to be sent out of order.

### SUMMARY

A method and system for fast video transcoding are disclosed. In one embodiment, the system comprises a processor, memory coupled to the processor, a video processor and a display. The video processor includes an input that receives MPEG-2 data; and an output that provides a bitstream to a display on a portable video device. The video processor also includes a transcoder that processes the MPEG-2 data and generates H.264 data. The H.264 data is one fourth the resolution of the MPEG-2 data.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates an exemplary computer architecture for use with the present system, according to one embodiment.

FIG. 2 illustrates a block diagram of an exemplary transcoding process, according to one embodiment of the present invention.

FIG. 3 illustrates a block diagram of an exemplary macroblock header transcoding process.

### DETAILED DESCRIPTION

A method and system for fast video transcoding are disclosed. In one embodiment, the system comprises a processor, memory coupled to the processor, a video processor and a display. The video processor includes an input that receives MPEG-2 data; and an output that provides a bitstream to a display on a portable video device. The video processor also includes a transcoder that processes the MPEG-2 data and generates H.264 data. The H.264 data is one fourth the resolution of the MPEG-2 data.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

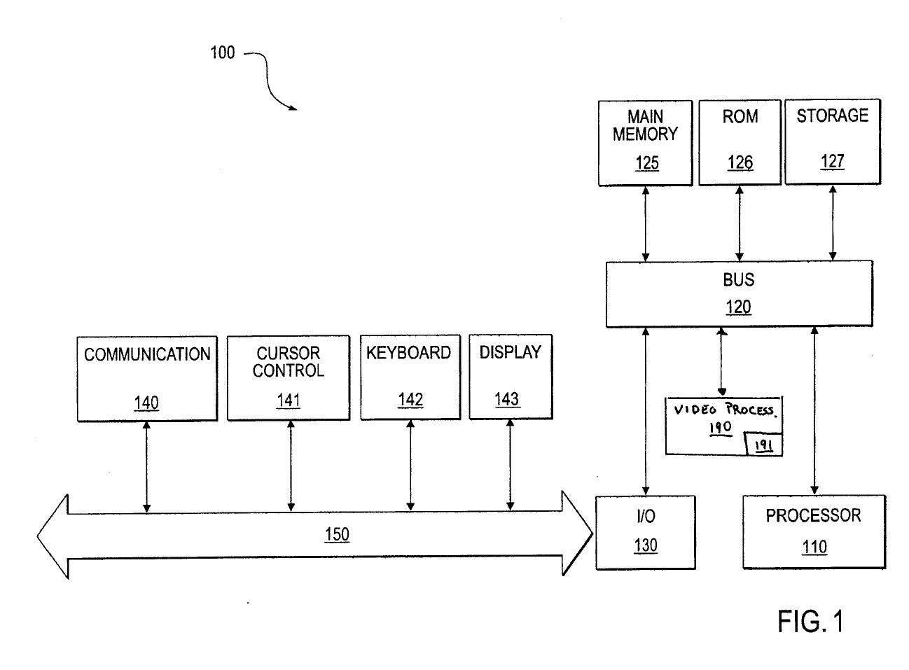

FIG. 1 illustrates an exemplary computer architecture 100 for use with the present system, according to one embodiment. Architecture 100 may be used in a personal computer, and mobile devices including cellular phones, smart phones, personal data assistants, personal game systems, mobile DVD players, and similar devices. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

One embodiment of architecture 100 includes a video processor 190 with a video transcoder 191. In one embodiment, transcoder 191 transcodes standard MPEG-2 to quarter resolution H.264. In another embodiment, transcoder 191 only processes macroblock information and transform coefficients in the frequency domain and; accordingly, it transcodes faster by not processing any pixels in the spatial domain. Video processor 190 transcodes 10× real-time DVD video to devices, such as portable video players. Transcoder 191 is implemented in hardware, according to one embodiment, although it may also be implemented in software.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141). For example, videos, photographs, and web pages may be presented to the user on the display device 143, which may be a high resolution LCD panel, or other similar display.

The communication device 140 is for accessing other computers or devices via a network. The communication device 140 may comprise a modem, a network interface card, a wireless network interface or other well known interface device, such as those used for coupling to Ethernet, token ring, or other types of networks.

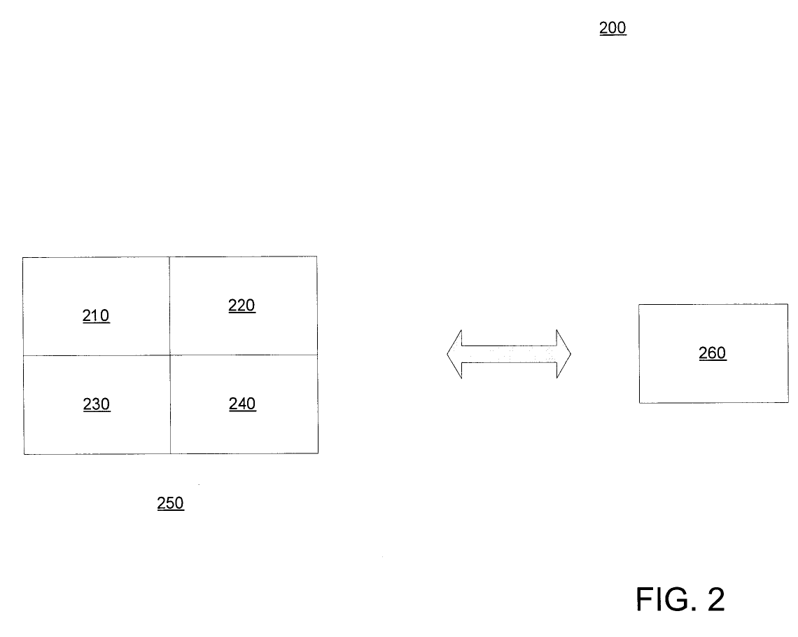

FIG. 2 illustrates a block diagram of an exemplary transcoding process 200, according to one embodiment of the present invention. In one embodiment frame 250 is an MPEG-2 standard frame consisting of four 16×16 macroblocks 210-240. Frame 260, according to one embodiment, is a 16×16 H.264 macroblock with four 8×8 subblocks. Frame 260 is rendered from frame 250 by discarding high frequency data contained in macroblocks 220-240. In one embodiment the high half of the horizontal frequency information is dropped, along with the high half of the vertical frequency information.

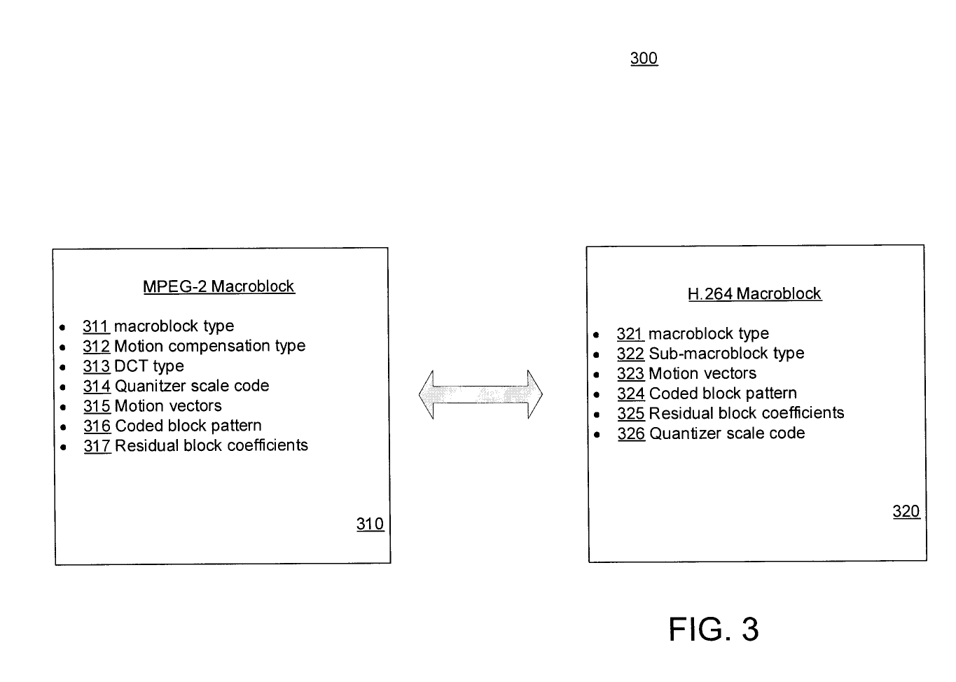

FIG. 3 illustrates a block diagram of an exemplary macroblock header transcoding process 300. Macroblock header 310 may be a MPEG-2 header. Macroblock type 311 may be Intra Pictures (I-Pictures) Predicted Pictures (P-Pictures); and Bidirectional Pictures (B-Pictures). Motion compensation type 312 may be progressive (frame mode) or interlaced (field mode). Quantizer scale code 314 indicates how much precision is used to represent each coefficient—for example, 8 bit precision. Motion vectors 315 have both horizontal and vertical components that indicate a motion offset from an old frame to the new frame. With progressive motion compensation there may be up to two motion vectors, whereas with interlaced motion compensation there may be up to four motion vectors. Coded block pattern 316 indicates which residual block coefficients 317 are all zeros. Block 317 contains transform coefficients of the difference from the values of the motion compensated block predicted from other frames.

Macroblock header 320 may include fields that are a subset of the full H.264 macroblock header as defined by the standard. Each field of macroblock header 320 is derived from fields in macroblock header 310 (or a number of macroblock headers 310). In one embodiment, macroblock type 321 is chosen to be bidirectional with 8×8 motion compensation vectors. Sub-macroblock type 322 may be chosen from L0 (forward motion compensation chosen from list 0 which includes an initial undisplayed grey frame as a predictor for intra blocks), L1 (backwards motion compensation chosen from list 1), and Bi where one motion vector is chosen from each of list 0 and list 1. Motion vectors 323 are differentially encoded from the median of three neighboring prior motion vectors. Coded block pattern 324 indicates which residual block coefficients are all zeros. Residual block coefficients 325 contains transform coefficients of the difference from the values of the motion compensated block predicted from other frames. Quantizer scale code 326 indicates how much precision is used to represent each coefficient—for example, 8 bit precision.

A special case occurs when the MPEG-2 frame is interlaced. According to one embodiment, transcoder 191 discards odd field motion vectors and odd blocks. Even blocks are split with a filter, for example, a 4 tap filter. The resulting quarter resolution H.264 frame is progressive.

A method and system for a fast video transcoder have been disclosed. Although the present methods and systems have been described with respect to specific examples and subsystems, it will be apparent to those of ordinary skill in the art that it is not limited to these specific examples or subsystems but extends to other embodiments as well.

I claim:

1. An apparatus, comprising:
an input that receives MPEG-2 data;
a transcoder that processes the MPEG-2 data and generates H.264 data, wherein the H.264 data is one fourth the resolution of the MPEG-2 data; and
an output that provides a bitstream having the H.264 data.

2. The apparatus of claim 1, wherein the transcoder processes the MPEG-2 data in a frequency domain only, to generate the H.264 data.

3. The apparatus of claim 2, wherein the transcoder maps MPEG-2 macroblock header fields to H.264 macroblock header fields,
wherein the MPEG-2 macroblocks include a first macroblock type, a motion type, a quantizer scale code, first motion vectors, a first coded block pattern, and first coefficient blocks, and
wherein the H.264 macroblock header fields include a second macroblock type, a sub-macroblock type, second motion vectors, a second coded block pattern, and second coefficient blocks.

4. The apparatus of claim 3, wherein the transcoder discards high frequency information in the MPEG-2 data.

5. The apparatus of claim 4, wherein the transcoder converts interlaced MPEG-2 data to progressive H.264 data.

6. The apparatus of claim 4, wherein the transcoder uses an undisplayed grey frame as a predictor for MPEG-2 macroblocks of type intra.

7. A processor-readable medium having stored thereon a plurality of instructions, said plurality of instructions when executed by a processor, cause said processor to perform:
receives MPEG-2 data;
transcoding MPEG-2 data into H.264 data, wherein the H.264 data is one fourth the resolution of the MPEG-2 data; and
outputting a bitstream having the H.264 data.

8. The processor-readable medium of claim 7, further comprising instructions for processing the MPEG-2 data in a frequency domain only, to generate the H.264 data.

9. The processor-readable medium of claim 8, further comprising instructions for mapping MPEG-2 macroblock header fields to H.264 macroblock header fields,
wherein the MPEG-2 macroblocks include a first macroblock type, a motion type, a quantizer scale code, first motion vectors, a first coded block pattern, and first coefficient blocks, and
wherein the H.264 macroblock header fields include a second macroblock type, a sub-macroblock type, second motion vectors, a second coded block pattern, and second coefficient blocks.

10. The processor-readable medium of claim 9, further comprising instructions for discarding high frequency information in the MPEG-2 data.

11. The processor-readable medium of claim 10, further comprising instructions for converting interlaced MPEG-2 data to progressive H.264 data.

12. The processor-readable medium of claim 10, further comprising instructions for using an undisplayed grey frame as a predictor for MPEG-2 macroblocks of type intra.

13. A system, comprising:
a processor;
memory coupled to the processor;
a display; and
a video processor, the video processor including
an input that receives MPEG-2 data;
a transcoder that processes the MPEG-2 data and generates H.264 data, wherein the H.264 data is one fourth the resolution of the MPEG-2 data; and
an output that provides a bitstream having the H.264 data.

14. The system of claim 13, wherein the transcoder processes the MPEG-2 data in a frequency domain only, to generate the H.264 data.

15. The system of claim 14, wherein the transcoder maps MPEG-2 macroblock header fields to H.264 macroblock header fields,
wherein the MPEG-2 macroblocks include a first macroblock type, a motion type, a quantizer scale code, first motion vectors, a first coded block pattern, and first coefficient blocks, and
wherein the H.264 macroblock header fields include a second macroblock type, a sub-macroblock type, second motion vectors, a second coded block pattern, and second coefficient blocks.

16. The system of claim 15, wherein the transcoder discards high frequency information in the MPEG-2 data.

17. The system of claim 16, wherein the transcoder converts interlaced MPEG-2 data to progressive H.264 data.

18. The system of claim 16, wherein the transcoder uses an undisplayed grey frame as a predictor for MPEG-2 macroblocks of type intra.
